(19) United States
(12) Patent Application Publication
(10) Pub. No.: US 2019/0042857 A1
(43) Pub. Date: Feb. 7, 2019

(54) INFORMATION PROCESSING SYSTEM AND INFORMATION PROCESSING METHOD

(71) Applicant: TOYOTA JIDOSHA KABUSHIKI KAISHA, Toyota-shi (JP)

(72) Inventors: Toshiki ENDO, Shiki-shi (JP); Chihiro INABA, Yokohama-shi (JP); Eisuke ADACHI, Kawasaki-shi (JP); Takashige HORI, Aisai-shi (JP)

(73) Assignee: TOYOTA JIDOSHA KABUSHIKI KAISHA, Toyota-shi (JP)

(21) Appl. No.: 16/046,346

(22) Filed: Jul. 26, 2018

(30) Foreign Application Priority Data
Aug. 4, 2017 (JP) 2017-151627

(51) Int. Cl. G06K 9/00; G06K 9/32; G01C 21/34

(52) U.S. Cl. CPC G06K 9/00791; G01C 21/3461; G06K 9/325

(57) ABSTRACT

An information processing system, comprises a data acquirer that acquires an image captured by a vehicle-mounted camera included in a first vehicle, and positional information of the first vehicle; an analyzer that analyzes a road condition in a periphery of the first vehicle based on one or more images that have been acquired; and an evaluator that assigns a cost value to a spot or a road link included in map data based on a result of analyzing the road condition and positional information corresponding to the image.

### BACKGROUND OF THE INVENTION

### Field of the Invention

The present invention relates to a technique for performing a route search.

### Description of the Related Art

A large number of route guidance apparatuses (navigation apparatuses) mounted to vehicles are in use. A general route guidance apparatus has a function of searching for a route which enables a destination to be reached at the earliest and providing the user with the retrieved route.

With respect to systems that navigate a vehicle traveling on a road, there is a need to perform a route search based on drivability instead of searching for a route based solely on a degree of congestion. As a technique related thereto, Japanese Patent Application Laid-open No. 2011-215080 describes a route search apparatus which calculates a cost with respect to a road based on obstacles and parked vehicles detected by a sensor.

### SUMMARY OF THE INVENTION

According to the apparatus described above, a route with fewer obstacles on roads can be guided. However, drivability is not always determined based solely on obstacles on roads. For example, although drivability is related to various elements including the number of pedestrians, a degree of necessity of lane changes, a speed of flow of other vehicles, and presence or absence of merging traffic, with conventional art, such elements cannot be taken into consideration when searching for a route.

In other words, with conventional art, there is a problem in that a route cannot be searched with accuracy using drivability as an index.

The present invention has been made in consideration of the problem described above and an object thereof is to provide map data for searching for a route based on drivability.

The present invention in its one aspect provides an information processing system, comprising a data acquirer that acquires an image captured by a vehicle-mounted camera included in a first vehicle, and positional information of the first vehicle; an analyzer that analyzes a road condition in a periphery of the first vehicle based on one or more images that have been acquired; and an evaluator that assigns a cost value to a spot or a road link included in map data based on a result of analyzing the road condition and positional information corresponding to the image.

The first vehicle is a vehicle which acquires an image at each spot on a road using a vehicle-mounted camera. There may be a plurality of the first vehicles. An image acquired by the first vehicle is collected by the data acquirer together with positional information corresponding to the first vehicle. Moreover, the image may be a single still image or an image constituted by a plurality of frames.

The analyzer is a unit which analyzes a road condition in a periphery of the first vehicle based on acquired images. Examples of analyzed road conditions include, but are not limited to, “large number of crossing pedestrians”, “many lane changes”, “fast flow of vehicles”, and “many taxis waiting for passengers”. The analyzer outputs the analysis results as, for example, identifiers representing a road condition.

The evaluator is a unit which, based on a result of an analysis, assigns a cost value to a corresponding spot or road link. A cost value is a value representing a cost in vehicular travel and examples thereof include, but are not limited to, a value representing difficulty of driving. According to these processes, a cost value can be assigned to a spot or a road link based on information collected from a vehicle traveling on a road. Moreover, a spot may be a point or a region.

Further, the analyzer may analyze a roughness of driving of another vehicle positioned in a vicinity of the first vehicle.

For example, the analyzer may analyze the roughness of driving of another vehicle by calculating a parameter (a speed, an acceleration, a yaw rate, a travel position, or the like) representing a travel condition of the other vehicle or a rate of change or the like of the parameter. In this manner, by calculating a cost value based on a roughness (or a smoothness) of driving of another vehicle traveling nearby, drivability can be accurately evaluated.

The information processing system may further comprise a route generator that generates a route to be traveled by a second vehicle based on the map data assigned with the cost value.

The route generator generates a route to be traveled by the second vehicle (for example, a vehicle driven by a user of a route guidance apparatus) based on map data to which a cost value has been assigned. Accordingly, a route with a low cost as a whole or, in other words, a route that is easy to drive can be generated.

Further, the route generator acquires an origin and a destination of the second vehicle and determines a route to be provided to a user based on a sum of cost values assigned to a plurality of routes connecting the origin and the destination.

For example, the user may be provided with a route with a smallest sum of cost values or a plurality of routes may be output in an order of sums of cost values.

Further, the evaluator may assign, when driving of a corresponding spot or road link is easier, a smaller cost value to the spot or the road link.

According to the configuration described above, a spot or a road link can be evaluated based on drivability and an entire route can be generated. Moreover, for example, drivability may be determined based on the numbers of obstacles and parked vehicles on roads, the number of pedestrians and bicycles, a degree of necessity of lane changes, a density of vehicles, road widths, and the like.

Further, the analyzer may generate, based on the image, event information representing a presence of a prescribed event that affects drivability in the periphery of the first vehicle, and the evaluator may assign a cost value to the spot or the road link based on one or more pieces of the event information.

In this manner, an event may be detected from an image and drivability may be determined based on the presence of a detected event. Moreover, one image does not necessarily include only one event. For example, a plurality of events may be detected from one image or an event may not be included in an image.

Further, a cost may be associated with the prescribed event, and the evaluator may calculate a cost value with respect to a target road link by adding up costs associated with events that are present on the road link.

By first associating a cost with each event and then adding up costs with respect to all events detected in a road link, a cost value with respect to the road link can be calculated in an efficient manner.

Further, the analyzer may detect a pedestrian from the image, and may generate the event information based on a behavior of the detected pedestrian.

A behavior of a pedestrian is a position, a motion, or the like of a detected pedestrian and examples thereof include, but are not limited to, entering a roadway, rushing out onto a roadway, crossing a roadway, and gathering around. Utilizing the presence of pedestrians as an element that affects drivability enables a cost value to be accurately calculated.

Further, the analyzer may detect another vehicle from the image, and may generate the event information based on a behavior of the detected other vehicle.

A behavior of another vehicle is a position, a motion, or the like of a detected other vehicle and examples thereof include, but are not limited to, a travel speed, a direction or frequency of lane changes, and temporary stopping. Utilizing the presence of other vehicles as an element that affects drivability enables a cost value to be accurately calculated.

Further, the analyzer may further determine a type of the detected other vehicle, and may generate the event information further based on the type.

The type of a vehicle may be a classification based on vehicle size (a large-size vehicle, a small-size vehicle, and the like) or a classification based on application (a passenger vehicle, a cargo vehicle, a passenger-carrying vehicle, and the like). For example, when another vehicle is a fixed route bus stopped at the side of the road, an event of “getting on/off at bus stop” may be generated.

Further, the analyzer may extract license plate information from the image, and may eliminate duplication of the event information based on the extracted license plate information.

When images are acquired from a plurality of vehicles, a same object may be included in a plurality of images. Therefore, by making a determination based on license plate information, duplication of event information can be prevented.

The information processing system may further comprise a unit that acquires information related to operations of public transportation, and the evaluator may assign the cost value by taking the information related to the operations of public transportation into consideration.

A road condition may change drastically depending on an operating status of public transportation. Therefore, accuracy can be increased by also taking information related to the operation of public transportation into consideration when generating a cost value.

Moreover, the present invention can be specified as an information processing system or an information processing apparatus which includes at least a part of the units described above. In addition, the present invention can also be specified as an information processing method carried out by the system or the apparatus. The processes and units described above may be implemented in any combination thereof insofar as technical contradictions do not arise.

According to the present invention, map data for searching for a route based on drivability can be provided.

### BRIEF DESCRIPTION OF THE DRAWINGS

FIG. 1 is a schematic view of a route guidance system according to a first embodiment;

FIG. 2 is a configuration diagram of the route guidance system according to the first embodiment;

FIG. 3 is a flow chart of processes executed by a vehicle-mounted terminal 200;

FIG. 4 is a flow chart of processes executed by a server apparatus 100;

FIG. 5 is a flow chart of processes executed by a vehicle-mounted terminal 300;

FIG. 6 shows an example of a screen provided to a user;

FIG. 7 is a configuration diagram of a route guidance system according to a second embodiment;

FIG. 8 is a configuration diagram of a route guidance system according to a third embodiment; and

FIG. 9 is a configuration diagram of a route guidance system according to a fourth embodiment.

### DESCRIPTION OF THE EMBODIMENTS

### First Embodiment

Outline of System

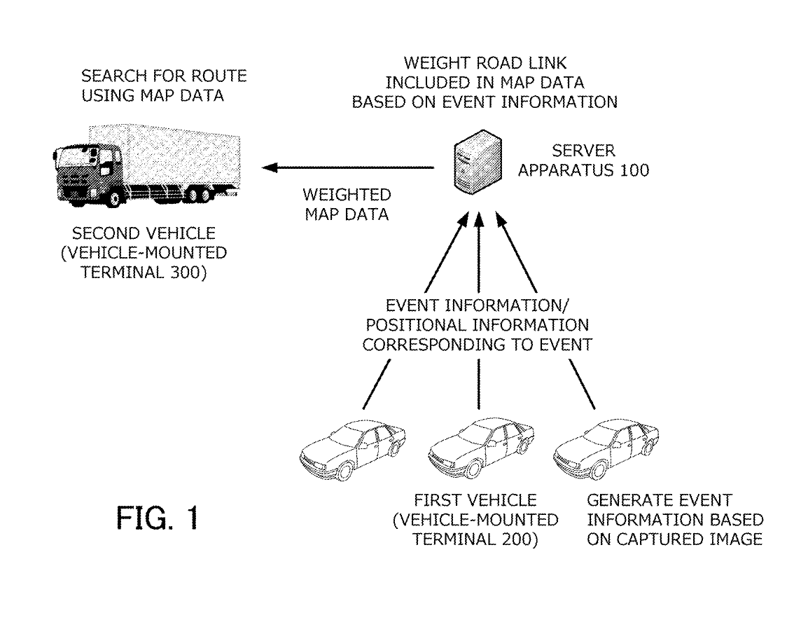

An outline of a route guidance system according to a first embodiment will be described with reference to FIG. 1. The route guidance system according to the first embodiment is a system which weights a road link included in map data based on information collected from a first vehicle and which uses the weighted map data to provide a second vehicle with route guidance.

A detailed description will now be given.

The first vehicle is a vehicle mounted with a vehicle-mounted camera capable of capturing images of the outside of the vehicle. There may be a plurality of the first vehicles. The first vehicle periodically captures images of the periphery of the vehicle using the vehicle-mounted camera, and analyzes the obtained images to generate event information (to be described later). In addition, the first vehicle transmits generated event information to a server apparatus 100 in association with positional information.

The server apparatus 100 is an apparatus which stores map data and which weights a road link included in the map data based on information collected from the first vehicle. When a request is made from a second vehicle, the map data having been weighted is transmitted to the second vehicle.

The second vehicle is a vehicle which performs a route search. The second vehicle downloads weighted map data from the server apparatus 100 and performs a route search using the map data.

System Configuration

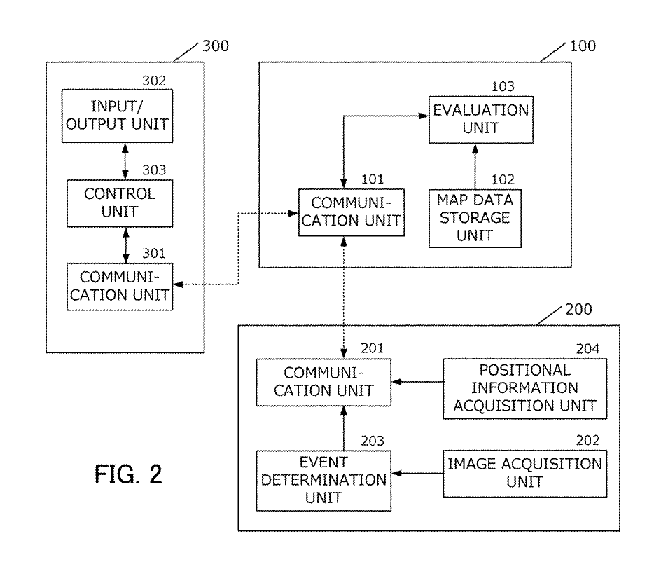

Next, a route search system according to the first embodiment will be described with reference to FIG. 2 which is a system configuration diagram. The route search system according to the first embodiment is constituted by the server apparatus 100, a vehicle-mounted terminal 200 mounted to the first vehicle, and a vehicle-mounted terminal 300 mounted to the second vehicle. Moreover, although FIG. 2 shows one of each of the vehicle-mounted terminals 200 and 300, the route search system according to the present embodiment can be configured so as to include a plurality of the vehicle-mounted terminals 200 and a plurality of the vehicle-mounted terminals 300.

First, the vehicle-mounted terminal 200 that is mounted to the first vehicle will be described.

The vehicle-mounted terminal 200 is a computer equipped with a function of collecting information of the periphery of the vehicle mounted with the terminal and transmitting the collected information to the server apparatus 100. The vehicle-mounted terminal 200 is configured so as to include a communication unit 201, an image acquisition unit 202, an event determination unit 203, and a positional information acquisition unit 204.

The communication unit 201 is a unit which communicates with the server apparatus 100 by accessing a network via a communication line (for example, a wireless LAN or a mobile phone network).

The image acquisition unit 202 is a unit which acquires an image of the periphery of the vehicle using a vehicle-mounted camera installed so as to be pointed toward the outside of the vehicle. For example, the vehicle-mounted camera may be a front camera, a back camera, or a side camera. The image acquisition unit 202 may output a still image or may output a continuous image or a moving image. Moreover, favorably, images are periodically acquired.

The event determination unit 203 is a unit which specifies an event occurring around the vehicle based on images acquired by the image acquisition unit 202. Any event may be specified as long as the event relates to drivability on a relevant road. Examples of events are as follows.

Events Related to State of Another Vehicle
Occurrence of lane change
Occurrence of deceleration or stopping not attributable to a traffic jam or traffic light
Occurrence of lane splitting by motorcycle
Detection of parked or stopped vehicle
Detection of people getting on/off or loading/unloading of cargo
Occurrence of overspeeding from prescribed speed
Occurrence of merging traffic
Detection of rough driving (overspeeding, abrupt acceleration, abrupt deceleration, abrupt steering, and the like)

Events Related to State of Pedestrian or Bicycle
Detection of pedestrian walking or bicycle being ridden on roadway
Detection of road crossing at other than crosswalks
Detection of person expected to cross road
Detection of person waiting for a bus or taxi

These events can be detected by analyzing an image (a still image, a continuous image, a moving image, or the like) acquired by the image acquisition unit 202. Since techniques for detecting a specific situation or event based on an image are well known, a detailed description will be omitted.

Moreover, an event may occur singly or may represent a frequency of occurrences of an event that occurs singly. In addition, an event other than those exemplified above may be detected.

Furthermore, an event may be specified by determining a type of vehicle included in an image. For example, when the vehicle is a taxi and hazard warning lights are flashing, a determination that “a passenger is getting on/off a taxi” can be made. In addition, when the vehicle is a truck with its rear doors open, a determination that “cargo is being loaded/unloaded” can be made.

The detected event is transmitted to the server apparatus 100 together with positional information acquired by the positional information acquisition unit 204 to be described below.

The positional information acquisition unit 204 is a unit that acquires a current position (latitude and longitude) of the vehicle-mounted terminal 200 from a GPS module (not shown) provided in the apparatus.

Next, the server apparatus 100 will be described.

The server apparatus 100 is configured so as to include a communication unit 101, a map data storage unit 102, and an evaluation unit 103.

The server apparatus 100 can be configured as a computer including an arithmetic processor such as a CPU, a main storage apparatus such as a RAM, an auxiliary storage apparatus such as an HDD, an SSD, or a DVD-ROM, a wired or wireless communication apparatus, an input apparatus such as a keyboard or a mouse, and a display apparatus such as a display. The server apparatus 100 need not necessarily be constituted by one computer, and the functions described below may be realized by a plurality of computers cooperating with each other.

The communication unit 101 is a unit that communicates with the vehicle-mounted terminal 200 by accessing a network via a communication line in a similar manner to the communication unit 201. In addition, the communication unit 101 is a unit that also communicates with the vehicle-mounted terminal 300 to be described later via a network.

The map data storage unit 102 is a unit that stores map data to be used to search for a route. Map data refers to road map data in which information on roads that can be traveled by vehicles is defined and, in the present embodiment, refers to data in which a connection relationship among roads are expressed by links and nodes. Moreover, different directions of travel on a same road may be considered different links.

The evaluation unit 103 is a unit which, based on event information received from the vehicle-mounted terminal 200, weights (assigns a cost value to) a road link included in the map data stored in the map data storage unit 102. In addition, when a request is made from the vehicle-mounted terminal 300 to be described below, the evaluation unit 103 transmits weighted map data to the vehicle-mounted terminal. A specific method will be described later.

Next, the vehicle-mounted terminal 300 that is mounted to the second vehicle will be described.

The vehicle-mounted terminal 300 is a computer which performs a route search using map data (weighted map data) received from the server apparatus 100. The vehicle-mounted terminal 300 is configured so as to include a communication unit 301, an input/output unit 302, and a control unit 303. The vehicle-mounted terminal 300 may be a navigation apparatus installed on a vehicle or a computer (a smartphone or the like) carried by an occupant of the vehicle.

The communication unit 301 is a unit that communicates with the server apparatus 100 by accessing a network via a communication line in a similar manner to the communication unit 201.

The input/output unit 302 is a unit which accepts an input operation performed by a user and which presents the user with information. In the present embodiment, the input/output unit 302 is constituted by a single touch panel display. In other words, the input/output unit 302 is constituted by a liquid crystal display and a control unit thereof and a touch panel and a control unit thereof.

The control unit 303 is a unit which performs a route search using map data (weighted map data) received from the server apparatus 100. A specific method will be described later.

Each of the server apparatus 100, the vehicle-mounted terminal 200, and the vehicle-mounted terminal 300 can be configured as an information processing apparatus including a CPU, a main storage apparatus, and an auxiliary storage apparatus. The respective units illustrated in FIG. 1 function as a result of a program stored in the auxiliary storage apparatus being loaded on the main storage apparatus and executed by the CPU. Alternatively, all of or a part of the illustrated functions may be executed using exclusively designed circuits.

Acquisition of Information by First Vehicle

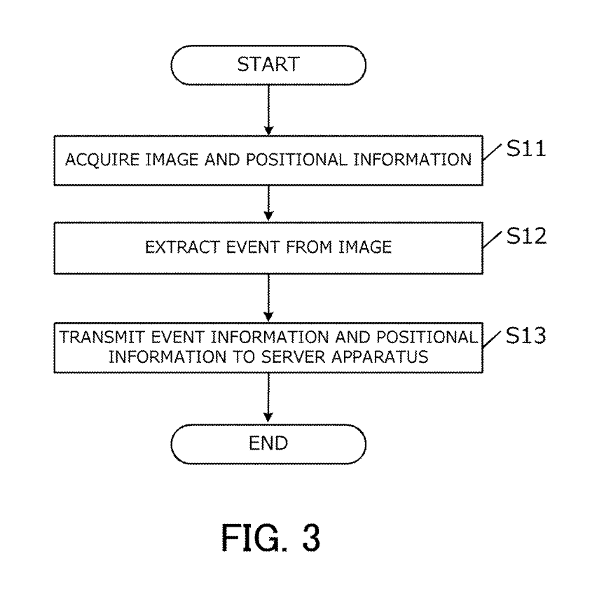

Next, processes by which the first vehicle (the vehicle-mounted terminal 200) acquires an image and transmits event information to the server apparatus 100 based on the acquired image will be described. FIG. 3 is a flow chart representing the processes executed by the vehicle-mounted terminal 200. The processes shown in FIG. 3 are periodically executed. For example, the processes shown in FIG. 3 may be executed every time a prescribed period of time lapses or every time a prescribed distance is traveled.

First, in step S11, the image acquisition unit 202 acquires an image of the outside of the vehicle via the vehicle-mounted camera, and the positional information acquisition unit 204 acquires positional information via a GPS module.

Next, in step S12, based on the acquired image, the event determination unit 203 determines an event included in the image, and generates event information. As described earlier, the image may be a still image or may be a continuous image or a moving image. When the image is a still image, a presence of an event (for example, an event of “a parked vehicle present”) may be determined by extracting a prescribed object (for example, a vehicle stopped at the side of the road) from inside the image, or when the image is a continuous image or a moving image, a presence of an event (for example, “a large number of crossings by pedestrians at other than crosswalks”) may be determined by tracking a motion of a prescribed object (for example, people). The motion of an object may be a relative motion with respect to the first vehicle or a motion represented by an absolute value (for example, a travel speed, a direction or a frequency of lane changes, and the like).

In addition, an event may be determined by determining a type of vehicle included in the image.

Furthermore, a plurality of pieces of event information may be generated with respect to the acquired image.

The event information generated by the event determination unit 203 and the positional information generated by the positional information acquisition unit 204 are transmitted in step S13 to the server apparatus 100 via the communication unit 201.

Weighting Based on Event Information

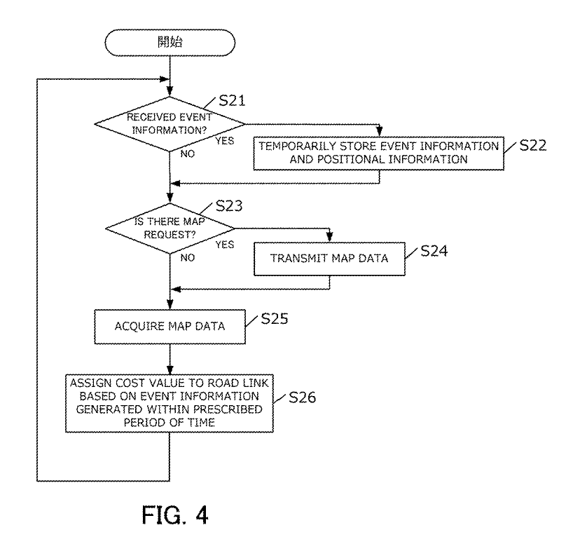

Next, processes by which the server apparatus 100 weights map data based on acquired event information will be described. FIG. 4 is a flow chart representing the processes executed by the server apparatus 100. The processes shown in FIG. 4 are periodically executed.

Moreover, in the present embodiment, it is assumed that the communication unit 101 has a receive buffer and is capable of buffering, at any time, information received from the vehicle-mounted terminal 200.

First, in step S21, the evaluation unit 103 refers to the receive buffer of the communication unit 101 and determines whether or not new event information is received from the vehicle-mounted terminal 200. At this point, when new event information is received, the evaluation unit 103 temporarily stores the received event information and positional information in association with each other (step S22).

Moreover, when there is event information that has already been stored, event information may be added or event information stored for more than a prescribed period of time may be deleted.

When new event information is not received, the process makes a transition to step S23.

Next, in step S23, a determination is made on whether or not the second vehicle (the vehicle-mounted terminal 300) has requested map data. At this point, when a request has been received, the evaluation unit 103 transmits the temporarily-stored weighted map data to the vehicle-mounted terminal 300 via the communication unit 101 (step S24). Moreover, when there is no weighted map data, unweighted map data may be transmitted instead. A process of weighting map data will be described in step S25 and thereafter.

Next, in step S25, the evaluation unit 103 reads map data from the map data storage unit 102 and temporarily stores the map data. The map data read at this point is default map data in which road links have not been weighted.

Next, in step S26, the evaluation unit 103 extracts event information generated within a prescribed period of time (for example, within 15 minutes, within 30 minutes, and the like) from the event information temporarily stored in step S22, and assigns a cost value to a road link included in the map data using the event information.

A method of calculating a cost value will now be described.

The evaluation unit 103 retains cost information corresponding to the event information transmitted from the vehicle-mounted terminal 200, and imparts a cost value Cᵢ according to the equation provided below to a road link i including a location where an event has occurred. In this case, c denotes a cost (a value affecting difficulty of driving) associated with each event, and n denotes the number of events. In other words, a sum of costs is obtained with respect to all events occurring in the corresponding road link i.

Cᵢ=c₁+c₂+ . . . +cₙ

The process of step S26 is performed with respect to all road links corresponding to the event information to be processed.

Once the process of step S26 is completed, a state is created where cost values are assigned to road links based on latest event information. In addition, by repeating the processes shown in FIG. 4, the assigned cost values are updated to latest values. The map data updated in this manner is transmitted in step S24 when a request is made from the vehicle-mounted terminal 300.

Searching for and Providing Route

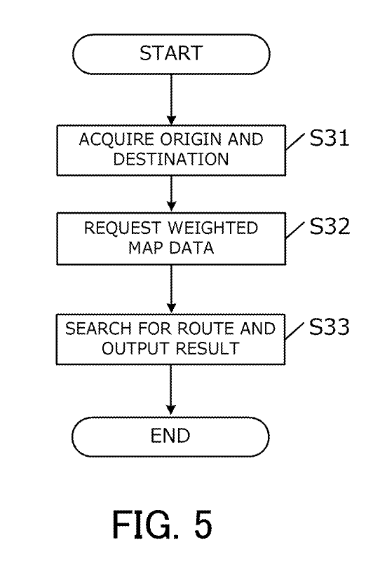

Next, processes by which the vehicle-mounted terminal 300 that is included in the second vehicle performs a route search will be described. FIG. 5 is a flow chart representing the processes executed by the vehicle-mounted terminal 300. The processes shown in FIG. 5 are executed based on a user's request.

First, the control unit 303 acquires information related to an origin and a destination from the user via the input/output unit 302 (step S31). Moreover, when the control unit 303 has map data, an origin and a destination may be selected on a map. In addition, when the control unit 303 is capable of acquiring positional information of the vehicle-mounted terminal 300, an origin may be determined based on the acquired positional information. Furthermore, when the control unit 303 has travel history information, a destination may be determined based on the information.

Next, the control unit 303 requests weighted map data from the server apparatus 100 (step S32). The received map data is temporarily stored by the control unit 303.

Next, the control unit 303 searches for a route connecting the origin and the destination using the weighted map data (step S33).

When searching for a route, a cost value assigned for each road link is used. For example, when sequentially moving from a first road link to an n-th road link, a total cost C can be represented by the following equation.

C=ΣCᵢ=C₁+C₂+ . . . +Cₙ

Moreover, while the cost values are treated the same for all road links in this case, the cost values may be multiplied by a coefficient that becomes smaller as a distance from a current position increases. For example, the total cost C can also be expressed by the following equation.

C=ΣαᵢCᵢ=α₁C₁+α₂C₂+ . . . +αₙCₙ

In the above equation, the coefficient αᵢ is a coefficient that becomes smaller as a distance from a current position increases. For example, the coefficient αᵢ can be a value calculated by dividing a distance from a corresponding road link to a destination by a distance from a current location to the destination. Alternatively, the coefficient αᵢ may be a prescribed value that decreases in accordance with distance. As a result, an event occurring in the vicinity can have a stronger influence while an event occurring at a remote location can have a weaker influence.

In addition, the coefficient by which the cost values are multiplied may be a coefficient based on other than a distance. For example, a cost value with respect to a road link may be multiplied by a coefficient determined in accordance with a road type.

C=ΣβᵢCᵢ=β₁C₁+β₂C₂+ . . . +βₙCₙ

In the above equation, the coefficient βᵢ is a coefficient that is determined in accordance with a road type. For example, the coefficient βᵢ can be a value that becomes smaller as a road width increases and becomes larger as the road width decreases. As a result, an influence of an event can be reduced with respect to roads that are easy to drive to begin with and an influence of an event can be increased with respect to roads that are not easy to drive.

Moreover, the two or more coefficients may be multiplied. In addition, the total cost C for each route may be calculated by further taking into consideration other elements such as a distance and an estimated travel time. In step S33, a route to be provided to the user is determined based on the total cost C. Moreover, the number of routes to be provided to the user need not be one. For example, after calculating a plurality of routes, the routes may be provided in an order of total costs. In addition, the routes may be displayed as a list in the order of total costs and be made selectable.

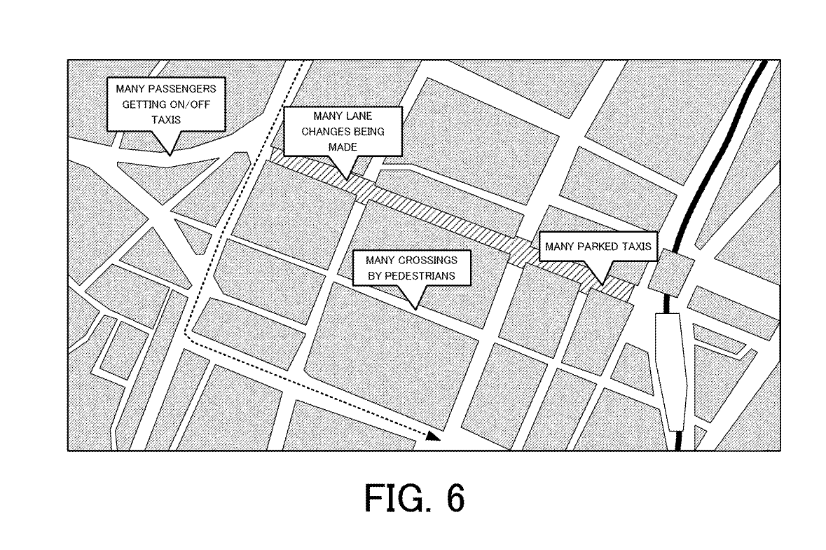

Furthermore, when there is a road link or an event with a relatively high cost value or a road link or an event having a large impact on total cost, an illustration may be provided as to what kind of event is occurring at what location. FIG. 6 shows an example of a screen for presenting a calculated route to the user. As shown, a spot where an event is detected may be indicated by a pointer or a word bubble, or a road link with a large cost value may be highlighted as indicated by hatchings. In addition, contents of an event may be displayed by an icon or text.

As described above, according to the first embodiment, based on an image captured by a vehicle-mounted camera, difficulty of driving (drivability) of a road can be evaluated and reflected in map data. In other words, route information with higher accuracy than simply evaluating a route based on road information and traffic congestion information can be provided. In addition, by periodically updating information, a current road condition can be evaluated nearly in real time.

Moreover, while the vehicle-mounted terminal 300 requests weighted map data from the server apparatus 100 in the first embodiment, map data may be periodically transmitted to the vehicle-mounted terminal 300 regardless of whether or not a request is made. In addition, only data related to a weight with respect to a road link may be transmitted to the vehicle-mounted terminal 300 instead of map data itself. For example, a list of IDs of road links and cost values corresponding to the road links may be transmitted. In a similar manner, only a list of IDs of events and costs corresponding to the events may be transmitted.

### Second Embodiment

The second embodiment is an embodiment in which the server apparatus 100 acquires information related to road traffic (hereinafter, traffic information) and weights a road link by taking the traffic information into consideration.

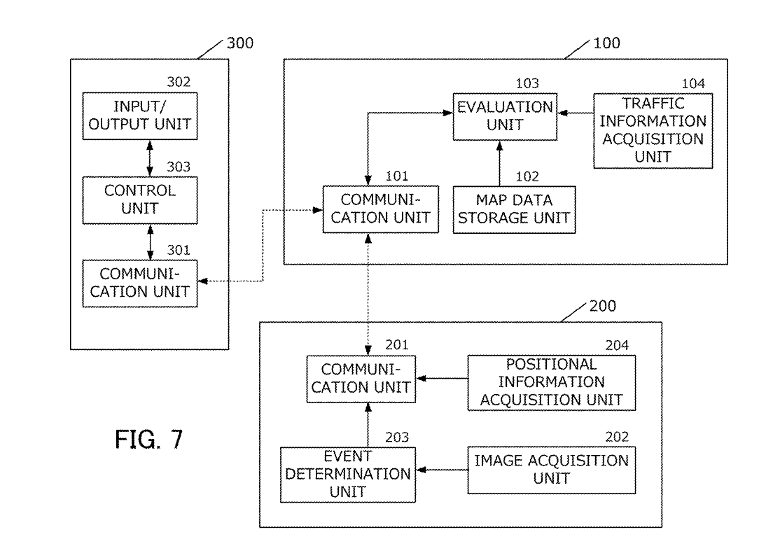

As shown in FIG. 7, the server apparatus 100 according to the second embodiment is provided with means (a traffic information acquisition unit 104) which acquires real-time traffic information. Examples of traffic information include, but are not limited to, operation information (routes, time points, positional information, and the like) of buses, information (information on taxi stands, positional information, and the like) of taxis, operation information (accident information and the like) of railways, information related to road construction, and information on crackdowns and checkpoints.

In addition, the server apparatus 100 (the evaluation unit 103) takes the acquired traffic information into consideration and imparts a cost value to a road link. For example, by collating event information acquired from the vehicle-mounted terminal 200 with traffic information, a degree of certainty with respect to the presence of buses and taxis can be improved. In addition, a cost value may be imparted using a single piece of traffic information. For example, when a location at which road construction is being carried out is known, it can be presumed that an event that interferes with vehicular travel has occurred. In addition, when railway operations are being suspended, a larger weight may be imparted to events having occurred around train stations which relate to buses and taxis.

### Third Embodiment

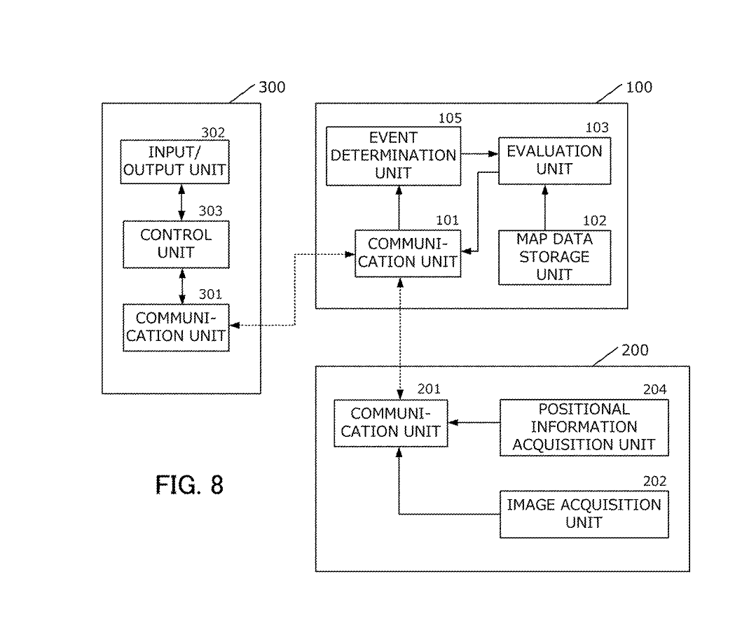

While the vehicle-mounted terminal 200 determines events in the first embodiment, the determination of events may be performed by the server apparatus 100 instead. For example, as shown in FIG. 8, the server apparatus 100 may be provided with an event determination unit 105 and the server apparatus 100 may perform event determination. In this case, the vehicle-mounted terminal 200 may transmit an image itself to the server apparatus 100 or may only transmit a feature amount extracted based on an image.

### Fourth Embodiment

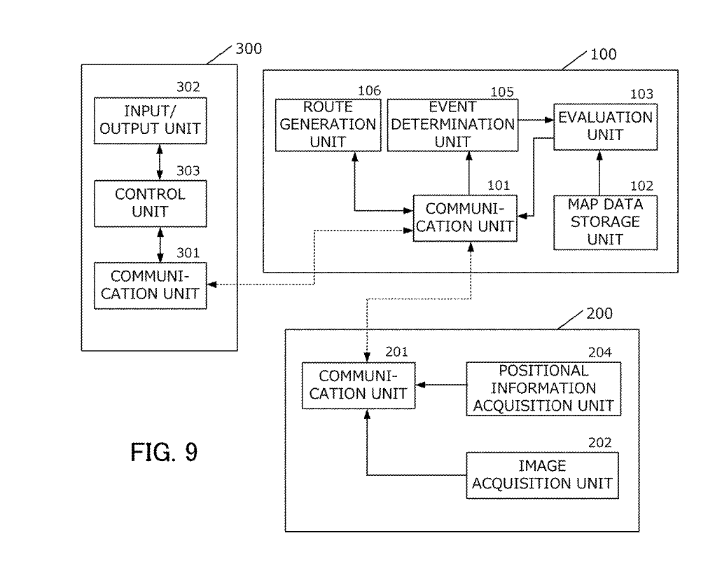

While the vehicle-mounted terminal 300 generates a route in the first embodiment, the generation of a route may be performed by the server apparatus 100 instead. For example, as shown in FIG. 9, the server apparatus 100 may be provided with a route generation unit 106 and the server apparatus 100 may perform route generation. In this case, the server apparatus 100 may acquire information on an origin and a destination from the vehicle-mounted terminal 300 and may return a generated route. In this case, an image for performing route guidance may be generated based on map data and transmitted to the vehicle-mounted terminal 300.

### Fifth Embodiment

In the first embodiment, since a plurality of vehicles (vehicle-mounted terminals 200) collect event information, there may be cases where a plurality of vehicle-mounted terminals 200 end up detecting a same vehicle and a weight cannot be correctly imparted. In order to accommodate such cases, in the fifth embodiment, license plate information of a vehicle is simultaneously read and collected with event information.

In the fifth embodiment, the event determination unit 203 included in the vehicle-mounted terminal 200 is further equipped with a function of reading license plate information based on an acquired image. In addition, the event determination unit 203 transmits the license plate information together with event information and positional information to the server apparatus 100.

Furthermore, when assigning a cost value in step S26, the server apparatus 100 (the evaluation unit 103) performs a process in which pieces of event information generated based on a same vehicle are considered the same piece of event information.

According to this mode, even when a plurality of vehicle-mounted terminals 200 recognize a same vehicle, since duplications do not occur, a cost value can be assigned with higher accuracy.

Moreover, identity determination cannot be made with respect to objects (for example, pedestrians and bicycles) that do not have license plate information. Therefore, by referring to positional information associated with event information, a determination of a same event may be made when positions or time points of events are close to each other. In addition, when events of a same type are included in plurality in a same road link or within a prescribed range, one event may be retained while ignoring the other events. Alternatively, a smaller weight may be imparted to the second and subsequent events.

Furthermore, based on features detected from an image corresponding to an event, an identity of an object having caused the event may be determined. For example, a feature amount of an object associated with the event may be transmitted together with event information to the server apparatus 100 to perform identity determination. While a shape, a color, a color distribution, or the like of an object can be used as a feature of the object, other features may be used instead.

(Modification)

The embodiments described above merely represent examples and the present invention can be implemented with various modifications without departing from the spirit and scope of the invention. For example, the respective embodiments may be implemented in combination.

In addition, while a cost value is assigned for each road link in the description of the embodiments, a cost value may be assigned to map data by other methods. For example, map data may be divided into a plurality of regions (for example, a mesh) and a cost value may be assigned for each unit region. In this case, a cost of an entire route may be obtained by adding up the cost values corresponding to the unit regions to be passed through.

Furthermore, a cost value may be directly assigned to a spot or a region corresponding to an event. In this case, a determination that a vehicle is to be affected by the event may be made when the vehicle passes through a vicinity of the spot or through the region.

In addition, while the vehicle-mounted terminal 200 for collecting information and the vehicle-mounted terminal 300 for searching for a route are described as separate apparatuses in the description of the embodiments, the vehicle-mounted terminals may be a same apparatus.

Furthermore, while an example of performing a route search based on map data assigned with a cost value is shown in the description of the embodiments, the present invention may be applied to systems other than route search systems. For example, the present invention may be applied to a system which provides a traveling vehicle with information related to a spot or a road which needs to be driven with caution.

What is claimed is:

1. An information processing system, comprising:
a data acquirer that acquires an image captured by a vehicle-mounted camera included in a first vehicle, and positional information of the first vehicle;
an analyzer that analyzes a road condition in a periphery of the first vehicle based on one or more images that have been acquired; and
an evaluator that assigns a cost value to a spot or a road link included in map data based on a result of analyzing the road condition and positional information corresponding to the image.

2. The information processing system according to claim 1, wherein
the analyzer analyzes a roughness of driving of another vehicle positioned in a vicinity of the first vehicle.

3. The information processing system according to claim 1, further comprising
a route generator that generates a route to be traveled by a second vehicle based on the map data assigned with the cost value.

4. The information processing system according to claim 3, wherein
the route generator acquires an origin and a destination of the second vehicle and determines a route to be provided to a user based on a sum of cost values assigned to a plurality of routes connecting the origin and the destination.

5. The information processing system according to claim 1, wherein
the evaluator assigns, when driving of a corresponding spot or road link is easier, a smaller cost value to the spot or the road link.

6. The information processing system according to claim 1, wherein
the analyzer generates, based on the image, event information representing a presence of a prescribed event that affects drivability in the periphery of the first vehicle, and
the evaluator assigns a cost value to the spot or the road link based on one or more pieces of the event information.

7. The information processing system according to claim 6, wherein
a cost is associated with the prescribed event, and
the evaluator calculates a cost value with respect to a target road link by adding up costs associated with events that are present on the road link.

8. The information processing system according to claim 6, wherein
the analyzer detects a pedestrian from the image, and generates the event information based on a behavior of the detected pedestrian.

9. The information processing system according to claim 6, wherein
the analyzer detects another vehicle from the image, and generates the event information based on a behavior of the detected other vehicle.

10. The information processing system according to claim 9, wherein
the analyzer further determines a type of the detected other vehicle, and generates the event information further based on the type.

11. The information processing system according to claim 9, wherein
the analyzer extracts license plate information from the image, and eliminates duplication of the event information based on the extracted license plate information.

12. The information processing system according to claim 1, further comprising
a unit that acquires information related to operations of public transportation, and
the evaluator assigns the cost value by taking the information related to the operations of public transportation into consideration.

13. An information processing method, comprising the steps of:
acquiring an image captured by a vehicle-mounted camera included in a first vehicle, and positional information of the first vehicle;
analyzing a road condition in a periphery of the first vehicle based on one or more images that have been acquired; and
assigning a cost value to a spot or a road link included in map data based on a result of analyzing the road condition and positional information corresponding to the image.
